(19) United States
(12) Patent Application Publication
(10) Pub. No.: US 2024/0197557 A1
(43) Pub. Date: Jun. 20, 2024

(54) MULTIFUNCTIONAL BELT FOR SLIMMING AND CONDITIONING CERVICAL SPINE PAIN AND COOLING

(71) Applicant: ZAIMING YANG, Anshun (CN)

(72) Inventor: ZAIMING YANG, Anshun (CN)

(21) Appl. No.: 18/230,242

(22) Filed: Aug. 4, 2023

(30) Foreign Application Priority Data
Dec. 20, 2022 (CN) 202223416074.2

(51) Int. Cl. A61H 11/00

(52) U.S. Cl. CPC A61H 11/00; A61H 2201/0207; A61H 2201/0214; A61H 2201/5007; A61H 2201/5025; A61H 2201/5043; A61H 2205/081

(57) ABSTRACT

A multifunctional belt for slimming, conditioning cervical spine pain and cooling, comprising a belt body, a cervical spine massage device, a cooling device, and a battery, wherein the cervical spine massage device is arranged inside the belt body, the cooling device is arranged above the cervical spine massage device, the battery is arranged on one side of the cervical massage device and is electrically connected to the cervical spine massage device and the cooling device. The cooling device comprises a refrigerating sheet and a beat dissipation plate, the refrigerating sheet is located between a first PU layer and a second PU layer, and the refrigerating sheet is electrically connected to a substrate, and the refrigerating sheet is electrically connected to the battery. The cervical spine massage device is connected with a control and adjustment device through wires.

### CROSS-REFERENCE TO RELATED APPLICATIONS

This is a U. S. patent application which claims the priority and benefit of Chinese Patent Application Number 202223416074. 2, filed on Dec. 20, 2022, the disclosure of which is incorporated herein by reference in its entirety.

### TECHNICAL FIELD

The present application relates to the technical field of a waist belt, in particular to a multifunctional belt for slimming, conditioning cervical spine pain and cooling.

### BACKGROUND

With the rapid development of the economy, people's living standards are getting higher and higher, and the number of obese people is also increasing, from 105 million in 1975 to 641 million in 2014. This means that among the nearly 7.3 billion people in the world, more than 600 million people are obese. According to figures published by relevant departments of our country, China and the United States are the countries with the largest number of obese people in the world. China has 43.2 million obese men and 46.4 million obese women, ranking first in the world. 17% of my country's urban population is obese, Beijing's obese population accounts for more than 30% of the total population, and 51% of China's children are obese. Obesity is not only a problem of poor body shape, but more importantly, obesity can cause many diseases and seriously endanger the health of the body. The harm of obesity to health has become a problem that cannot be ignored. However, blind dieting and exercising methods that cannot be constantly adhered to have brought counter-effects to people who need to lose weight. The weight-loss belts sold on the market have large and clumsy vibration devices, and cannot obtain corresponding weight-loss effects.

With the changes in people's lifestyles, such as using computers for a long time, bowing their heads or working at desks, and lack of daily exercise, the prevalence of cervical spondylosis continues to rise, and the onset is getting younger and younger. Cervical spondylosis is based on the degenerative changes of the cervical intervertebral disc, involving the surrounding tissues and structures (such as cervical bone hyperplasia, intervertebral disc herniation, nerve root, spinal cord, vertebral artery, sympathetic nerve compression, etc.), neck pain, Symptoms such as stiffness. At present, the traditional ways of treating and regulating the cervical spine are generally oral medicine, external application of medicine, traction therapy, etc. However, this kind of disease requires long-term rehabilitation and conditioning. Long-term internal and external application of drugs is not only costly, but also causes side effects to the human body. Long-term traction treatment requires special time, and it is difficult to persist for a long time. Therefore, be badly in need of a kind of belt that is convenient and effective, scientific and healthy, safe and comfortable with thin body and cervical vertebra pain conditioning function, in order to satisfy people's demand.

Chinese patent CN209518305U discloses a belt with a built-in cooling function. Inside the belt body, blowers facing away from each other are arranged, and the airflow generated makes sweat evaporate quickly to achieve the effect of cooling. In the comparative patent, two rotating blades are set in the belt, and the belt is wrapped around the waist when in use, so the airflow cannot be transmitted to various parts of the belt, and the cooling effect is poor.

Chinese patent CN218852019U discloses a belt with cooling function, comprising a belt, characterized in that: One end of the belt is fixedly installed with a buckle, the inner side of the belt is fixedly installed with an ice water belt, the upper end of the belt is provided with a groove, a water injection pipe is fixedly installed on the outside of the ice water belt, and a water absorbing layer is fixedly installed on the inside of the ice water belt. A casing is fixedly installed on the outside of the belt, a refrigerating sheet is fixedly installed inside the belt, a heat dissipation plate is fixedly installed inside the casing, and a heat conduction rod is fixedly installed on the outside of the refrigerating sheet. The inside of the casing is fitted with a battery, and the outer side of the casing is provided with a control switch, thereby realizing the belt with cooling function. An ice water belt is arranged on the inner side of the belt, and ice water can be added to the ice water belt through a water injection pipe. A casing is arranged on the back side of the belt, and a cooling sheet is arranged between the casing and the ice water belt. The refrigerating sheet conducts the heat in the ice water to the cooling plate through the heat conduction rod, and then transfers it to the outside of the casing, so that the ice water is kept at a certain temperature, and the ice water cools down the user, improving the user's wearing comfort.

### SUMMARY

The purpose of the present application is to solve the above-mentioned technical problems and provide a new type of multifunctional belt for slimming and conditioning cervical spine pain and cooling. By bonding a heat dissipation surface of the refrigerating sheet to the heat dissipation plate, the refrigerating sheet transfers heat to the cooling plate, and then to the outside of the belt body, so that the refrigerating sheet is kept at a certain temperature, and the refrigerating sheet cools down the user, making it comfortable to wear. The cervical spine massage device is connected with a control and adjustment device through wires, and the intensity at the massage point is controlled and adjusted through the control and adjustment device, so as to massage the acupoints at the abdomen and cervical spine of the human body.

The application is achieved through the following technical solutions:

A multifunctional belt for slimming, conditioning cervical spine pain and cooling, comprising a belt body, a cervical spine massage device, a cooling device, and a battery, wherein the cervical spine massage device is arranged inside the belt body, the cooling device is arranged above the cervical spine massage device, the battery is arranged on one side of the cervical massage device and is electrically connected to the cervical spine massage device and the cooling device, wherein the belt body comprises a first PU layer, high-temperature-resistant double-sided adhesive tapes, a conductive film layer, a second PU layer, and a silicon layer, wherein the conductive film layer is arranged below the first PU layer, a high temperature resistant double-sided adhesive is arranged between the first PU layer and the conductive film layer, the second PU layer is arranged below the conductive film layer, and a high temperature-resistant double-sided adhesive is also arranged between the conductive film layer and the second PU layer, the silicon layer is arranged below the second PU layer, and the conductive film layer is electrically connected to the cervical spine massage device, wherein the cervical spine massage device comprises a substrate, massage points, and wires, the substrate is located below the conductive film layer, Several massage points are arranged on the substrate, one side of the substrate is provided with wires, the substrate is electrically connected to the massage points and the wires, the substrate is electrically connected to the conductive film layer, and the substrate is electrically connected to the battery, wherein the cooling device comprises a refrigerating sheet and a heat dissipation plate, the refrigerating sheet is located between the first PU layer and the second PU layer, and the refrigerating sheet is electrically connected to the substrate, and the refrigerating sheet is electrically connected to the battery, wherein the refrigerating sheet transfers heat to the cooling plate by bonding a heat dissipation surface of the refrigerating sheet to the heat dissipation plate.

Further, the belt body further comprises a heating sheet, the heating sheet is located between the first PU layer and the conductive film layer, and a high-temperature-resistant double-sided adhesive tape is arranged between the first PU layer and the heating sheet, the heating sheet is electrically connected to the conductive film layer, the heating sheet is electrically connected to the substrate, and the heating sheet is electrically connected to the battery.

Further, the belt body further comprises an SBR layer and a thermal insulation cotton layer, the SBR layer is located below the first PU layer, the conductive film layer is arranged below the SBR layer, and the thermal insulation cotton layer is arranged below the conductive film layer.

Further, the multifunctional belt for slimming, conditioning cervical spine pain and cooling further comprises a control and adjustment device, and the control and adjustment device is located in middle of the surface of the belt body, wherein the control and adjustment device is electrically connected to the cervical spine massage device, the control and adjustment device is electrically connected to the cooling device, and the control and adjustment device is electrically connected to the battery; the control and adjustment device comprises a housing, a control circuit board, control and adjustment buttons, a display screen, wherein the control circuit board is arranged inside the housing, the control and adjustment buttons are arranged on the control circuit board, the display screen is arranged above the housing, and the control circuit board is electrically connected with the control and adjustment button and the display screen, the control circuit board is electrically connected to the conductive film layer, the control circuit board is electrically connected to the heating sheet, and the control circuit board is electrically connected to the substrate, the control and adjustment buttons are electrically connected with the substrate and the massage points, wherein several contacts are arranged on bottom of the housing, and the contacts are electrically connected to contacts on an outer surface of the belt body, and the contacts on the outer surface of the belt body are electrically connected to the conductive film layer through wires, the control circuit board is electrically connected to the refrigerating sheet through wires, and the control and adjustment buttons are electrically connected to the refrigerating sheet.

Further, a plurality of installation holes are arranged in an inner layer of the silicon layer, and the massage points on the substrate protrude from an inner surface of the silicon layer through the installation holes, and an inner surface of the substrate of the massage points is attached to an outer surface of the inner layer of the silicon layer, and a massage area is provided in middle of the outer surface of the substrate of the massage points, and a plurality of massage protrusions are arranged on the massage area.

Further, the heating sheet is a graphene heating sheet, and the graphene heating sheet is heated by DC current.

Further, one side of the heating sheet is provided with a conductive electrode, the conductive electrode on the heating sheet is electrically connected to the conductive film layer, and the conductive electrode is electrically connected to the battery.

Further, the wires are a flexible and flat structure.

Further, the first PU layer and the second PU layer are made of leather, weaving and canvas.

The beneficial effect of this application is:
(1) The structure is simple, it has the function for slimming, conditioning cervical spine pain, and cooling. It is easy to wear, and it is designed according to the natural curve of the human body. It conforms to the principles of ergonomics, is comfortable to wear, and does not affect the daily life of the wearer;
(2) The cervical spine massage device is connected to the control and adjustment device through flexible and flat wires. The control and adjustment device controls and adjusts the strength at the massage point, so as to massage the acupoints on the abdomen and cervical spine of the human body, which not only promotes human blood circulation and health care, and the slimming effect is greatly increased;
(3) The cervical spine massage device can massage the acupoint massage areas of the human abdomen and cervical spine to regulate the pain of the cervical spine, and there is no need to deliberately prepare the conditioning time, and it is easy to persist for a long time;
(4) There is also a heating sheet inside the multi-functional belt for slimming and conditioning cervical spine pain and cooling, which increases the heating effect;
(5) There is also a cooling sheet inside the multi-functional belt for slimming and conditioning cervical spine pain and cooling, which increases the cooling effect and is good.

### BRIEF DESCRIPTION OF DRAWINGS

FIG. 1 is a structural schematic diagram of the multi-functional belt for slimming and conditioning cervical spine pain and cooling and control and adjustment device according to the present application;

FIG. 2 is a structural schematic diagram of the present application, without the control and adjustment device;

FIG. 3 is a structural schematic diagram of the bottom of the multi-functional belt for slimming and conditioning cervical spine pain and cooling of the present application;

FIG. 4 is a structural schematic diagram of the internal embodiment 1 of the belt of the present application;

FIG. 5 is a structural schematic diagram of the internal embodiment 2 of the belt of the present application;

FIG. 6 is a structural schematic diagram of the internal embodiment 3 of the belt of the present application;

FIG. 7 is a front structural schematic diagram of the control and adjustment device of the present application;

FIG. 8 is a back structural schematic diagram of the control and adjustment device of the present application;

FIG. 9 is an explosion structural schematic diagram of the cervical spine massage device, the first PU layer, the heating sheet, the second PU layer and the cooling sheet of the present application;

FIG. 10 is a structural schematic diagram of a circuit board of the cervical spine massage device of the present application;

FIG. 11 is a schematic cross-sectional structural diagram of the cooling device of the present application.

Reference signs: 1. Belt body; 11. First PU layer, 12. High temperature resistant double-sided adhesive tape; 13. Conductive film layer; 14. Second PU layer, 15. Silicone layer, 16. Heating sheet; 17. SBR layer, 18. Insulation cotton layer, 19, Contact; 2, Cervical spine massage device; 21, Substrate; 22, Massage point; 23, Wire 3, Cooling device; 31, Refrigerating sheet; 32, Cooling plate; 4, Battery; 5, Control and adjustment device; 51, Housing; 52, Control circuit board; 53, Control and adjustment button; 54, Display screen; 55, Contact.

### DETAILED DESCRIPTION

The present application will be further described below in conjunction with the accompanying drawings and specific embodiments:

Unless otherwise defined, all technical and scientific terms used herein have the same meaning as commonly understood by those skilled in the technical field of the application; The terms used in the description of the application herein are only for the purpose of describing specific embodiments, and are not intended to limit the application; The terms “comprising” and “including” and any variations thereof in the specification and claims of the present application and the above descriptions of the drawings are intended to cover non-exclusive inclusion. The terms “first”, “second” and the like in the description and claims of the present application or the above drawings are used to distinguish different objects, rather than to describe a specific order.

Reference herein to an “embodiment” means that a particular feature, structure, or characteristic described in connection with the embodiment can be included in at least one embodiment of the present application. The various places in the specification where this phrase appears are not necessarily all referring to the same embodiment, nor are separate or alternative embodiments mutually exclusive of other embodiments. It is understood explicitly and implicitly by those skilled in the art that the embodiments described herein can be combined with other embodiments.

### Embodiment 1

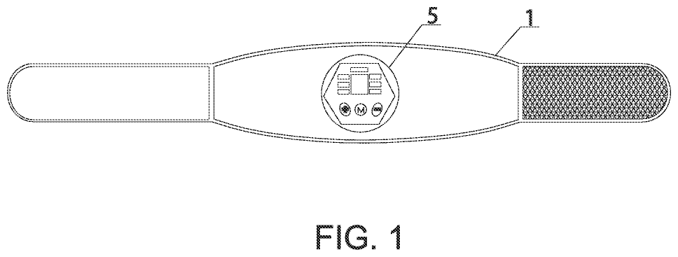

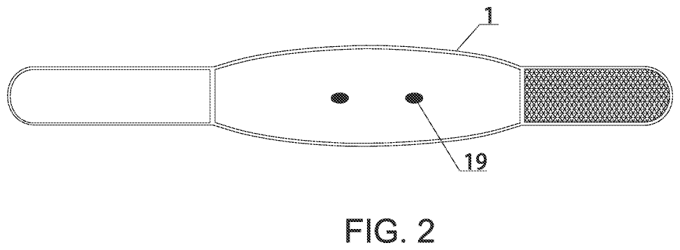

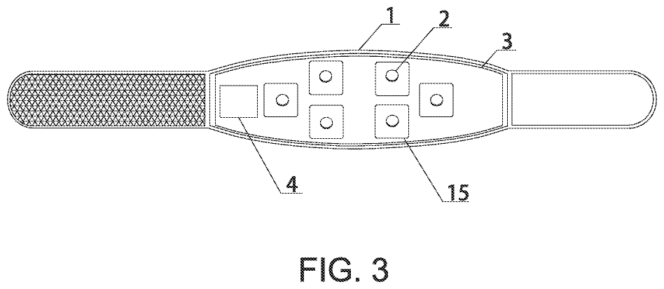

Referring to FIGS. 1-3, a multi-functional belt for slimming and conditioning cervical spine pain and cooling comprises a belt body 1, a cervical spine massage device 2, a cooling device 3, and a battery 4, wherein the cervical spine massage device 2 is arranged inside the belt body 1, the cooling device 3 is arranged above the cervical spine massage device 2, the battery 4 is arranged on one side of the cervical massage device 2 and is electrically connected to the cervical spine massage device 2 and the cooling device 3, wherein the belt body 1 comprises a first PU layer 11, high-temperature-resistant double-sided adhesive tapes 12, a conductive film layer 13, a second PU layer 14, and a silicon layer 15, wherein the conductive film layer 13 is arranged below the first PU layer 11, a high temperature resistant double-sided adhesive 12 is arranged between the first PU layer 11 and the conductive film layer 13, the second PU layer 14 is arranged below the conductive film layer 13, and a high temperature-resistant double-sided adhesive 12 is also arranged between the conductive film layer 13 and the second PU layer 14, the silicon layer 15 is arranged below the second PU layer 14, and the conductive film layer 13 is electrically connected to the cervical spine massage device 2, wherein the cervical spine massage device 2 comprises a substrate 21, massage points 22, and wires 23, the substrate 21 is located below the conductive film layer 13, several massage points 22 are arranged on the substrate 21, one side of the substrate 21 is provided with wires 23, the substrate 21 is electrically connected to the massage points 22 and the wires 23, the substrate 21 is electrically connected to the conductive film layer 13, wherein the cooling device 3 comprises a refrigerating sheet 31 and a heat dissipation plate 32, the refrigerating sheet 31 is located between the first PU layer 11 and the second PU layer 14, and the refrigerating sheet 31 is electrically connected to the substrate 21, and the refrigerating sheet 31 is electrically connected to the battery 4, wherein the refrigerating sheet 31 transfers heat to the cooling plate 32 by bonding a heat dissipation surface of the refrigerating sheet 31 to the heat dissipation plate 32. Thus, the intensity of the massage point 22 can be regulated through the control of the control and adjustment device 5, so as to massage the acupoints of the abdomen and cervical spine of the human body. This not only promotes the blood circulation of the human body and greatly increases the effect of health care and weight loss, but also solves the cooling problem.

### Embodiment 2

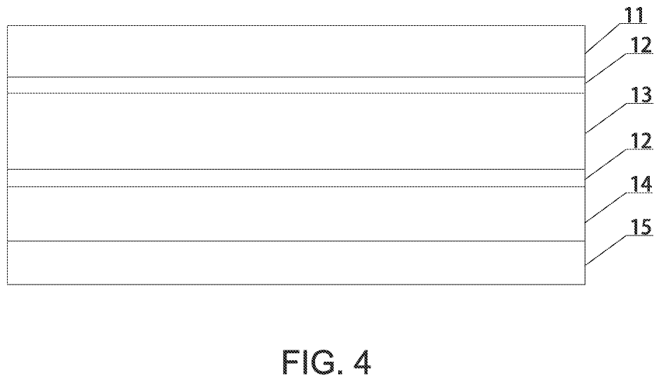

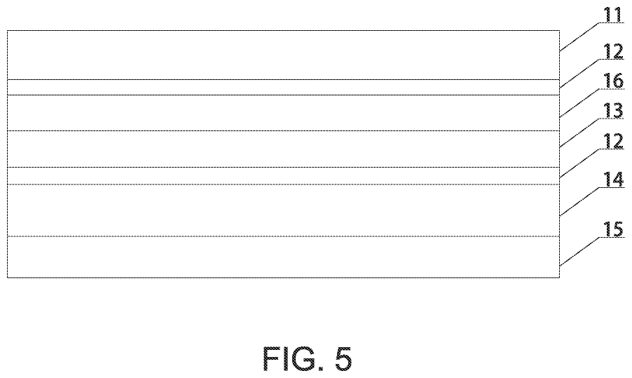

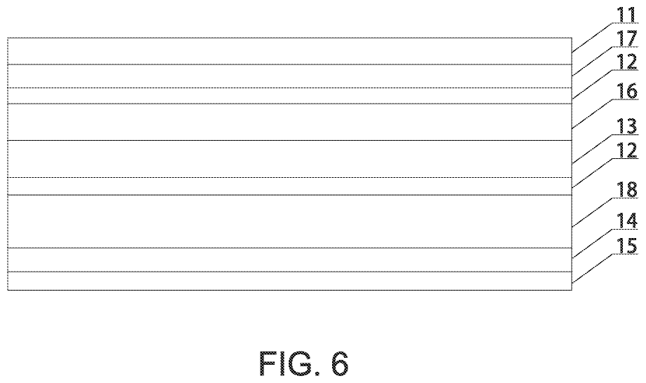

Referring to FIGS. 4-6, the belt body 1 also comprises a heating sheet 16, the heating sheet 16 is located between the first PU layer 11 and the conductive film layer 13, and a high-temperature-resistant double-sided adhesive tape 12 is arranged between the first PU layer 11 and the heating sheet 16, the heating sheet 16 is electrically connected to the conductive film layer 13, the heating sheet 16 is electrically connected to the substrate 21, and the heating sheet 16 is electrically connected to the battery 4.

Preferably, the belt body 1 further comprises an SBR layer 17 and a thermal insulation cotton layer 18, the SBR layer 17 is located below the first PU layer 11, the conductive film layer 13 is arranged below the SBR layer 17, and the thermal insulation cotton layer 18 is arranged below the conductive film layer 13, thereby achieving a better thermal insulation effect.

### Embodiment 3

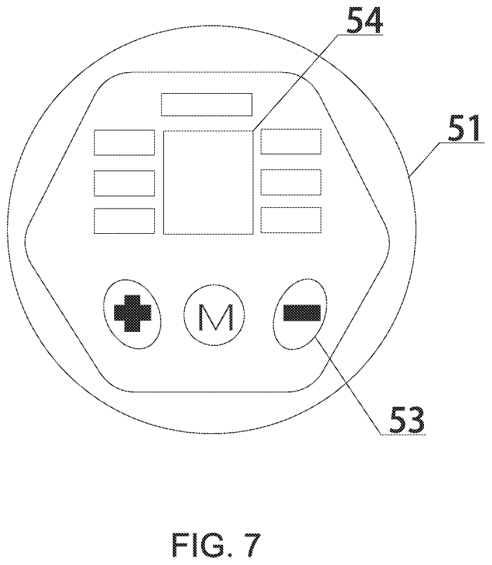

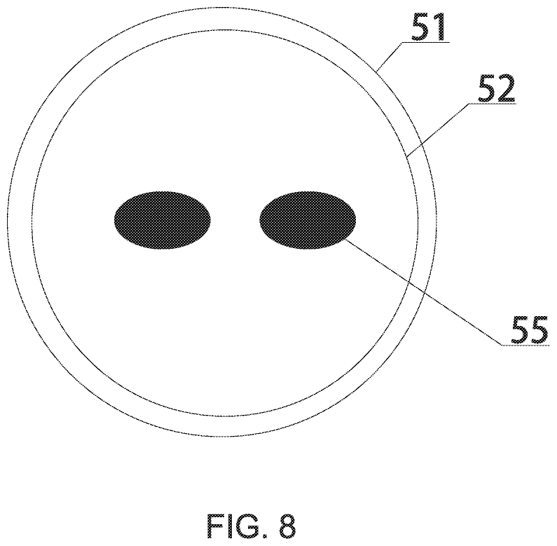

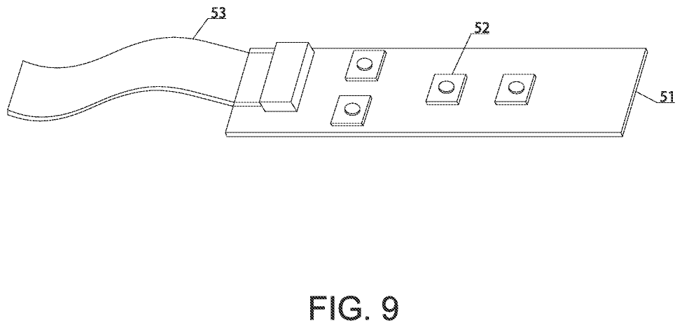

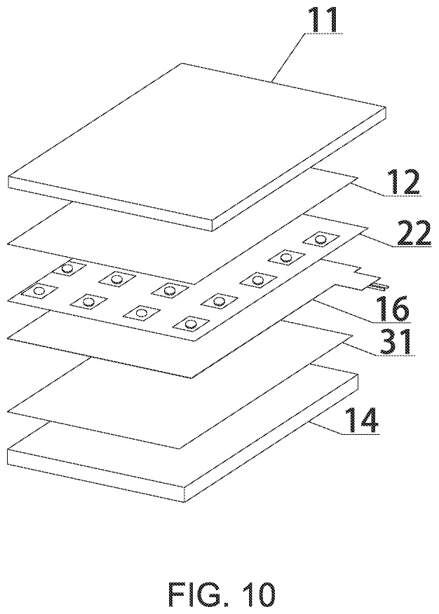

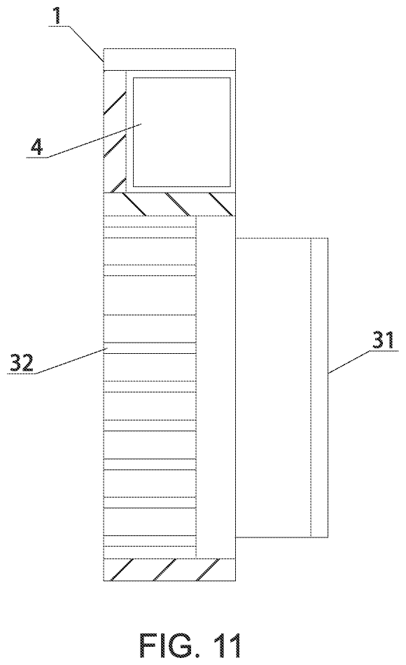

Referring to FIGS. 7-11, it also comprises a control and adjustment device 5, and the control and adjustment device 5 is located in middle of the surface of the belt body 1, wherein the control and adjustment device 5 is electrically connected to the cervical spine massage device 2, the control and adjustment device 5 is electrically connected to the cooling device 3, and the control and adjustment device 5 is electrically connected to the battery 4; the control and adjustment device 5 comprises a housing 51, a control circuit board 52, control and adjustment buttons 53, a display screen 54, wherein the control circuit board 52 is arranged inside the housing 51, the control and adjustment buttons 53 are arranged on the control circuit board 52, the display screen 54 is arranged above the housing 51, and the control circuit board 52 is electrically connected with the control and adjustment button 53 and the display screen 54, the control circuit board 52 is electrically connected to the conductive film layer 13, the control circuit board 52 is electrically connected to the heating sheet 16, and the control circuit board 52 is electrically connected to the substrate 21, the control and adjustment buttons 53 are electrically connected with the substrate 21 and the massage points 22, wherein several contacts 55 are arranged on bottom of the housing 51, and the contacts 55 are electrically connected to contacts 55 on an outer surface of the belt body 1, and the contacts 19 on the outer surface of the belt body 1 are electrically connected to the conductive film layer 13 through wires 23, the control circuit board 52 is electrically connected to the refrigerating sheet 31 through wires 23, and the control and adjustment buttons 53 are electrically connected to the refrigerating sheet 31.

Preferably, a plurality of installation holes are arranged in an inner layer of the silicon layer 15, and the massage points 22 on the substrate 21 protrude from an inner surface of the silicon layer 15 through the installation holes, and an inner surface of the substrate 21 of the massage points 22 is attached to an outer surface of the inner layer of the silicon layer 15, and a massage area is provided in middle of the outer surface of the substrate 21 of the massage points 22, and a plurality of massage protrusions are arranged on the massage area.

Preferably, the heating sheet 16 is a graphene heating sheet, and the graphene heating sheet is heated by DC current.

Preferably, one side of the heating sheet 16 is provided with a conductive electrode, the conductive electrode on the heating sheet 16 is electrically connected to the conductive film 13, and the conductive electrode is electrically connected to the battery 4.

Preferably, the conductive film layer 13 is made of metal.

Preferably, the metal is gold, silver, copper, steel, aluminum or gold alloy, silver alloy, copper alloy, steel alloy, aluminum alloy.

Preferably, the wires 23 are a flexible and flat structure.

Preferably, the first PU layer 11 and the second PU layer 14 are made of leather, weaving and canvas.

When using, the user first wraps the belt body 1 around the waist, and buckle the thorny side of the Velcro of the belt body 1 according to the actual waist circumference on the hairy side of the Velcro of the belt body 1. By fitting and fixing the belt body 1, activating the control and adjustment device 5 through the control and adjustment button 53, adjusting the mode of the control and adjustment device 5, so that the belt body 1 can be used for normal training of the waist. The control and adjustment devices 5 are all controlled by the control circuit board 52, and there are multiple current intensity ranges and multiple pulse frequency modes. The pulse current generated by the control and adjustment device 5 passes through the contacts 19 on the outer surface of the belt body 1, and then is transmitted to the conductive film layer 13 and the massage points 22 on the substrate 21 through the wires 23 to stimulate the nerves and contract the muscles. The acupuncture points on the abdomen and cervical spine of the human body are massaged. This not only promotes the blood circulation of the human body, but also greatly increases the effect of health care and weight loss.

According to the disclosure and teaching of the above specification, those skilled in the art to which the present application belongs can also make appropriate changes and modifications to the above embodiment. Therefore, the present application is not limited to the specific embodiments disclosed and described above, and some modifications and changes to the present application should also fall within the protection scope of the claims of the present application. In addition, although some specific terms are used in this specification, these terms are only for convenience of description and do not constitute any limitation to the present application.

What is claimed is:

1. A multifunctional belt for slimming, conditioning cervical spine pain and cooling, comprising a belt body, a cervical spine massage device, a cooling device, and a battery, wherein the cervical spine massage device is arranged inside the belt body, the cooling device is arranged above the cervical spine massage device, the battery is arranged on one side of the cervical massage device and is electrically connected to the cervical spine massage device and the cooling device, wherein the belt body comprises a first PU layer, high-temperature-resistant double-sided adhesive tapes, a conductive film layer, a second PU layer, and a silicon layer, wherein the conductive film layer is arranged below the first PU layer, a high temperature resistant double-sided adhesive is arranged between the first PU layer and the conductive film layer, the second PU layer is arranged below the conductive film layer, and a high temperature-resistant double-sided adhesive is also arranged between the conductive film layer and the second PU layer, the silicon layer is arranged below the second PU layer, and the conductive film layer is electrically connected to the cervical spine massage device, wherein the cervical spine massage device comprises a substrate, massage points, and wires, the substrate is located below the conductive film layer, several massage points are arranged on the substrate, one side of the substrate is provided with wires, the substrate is electrically connected to the massage points and the wires, the substrate is electrically connected to the conductive film layer, and the substrate is electrically connected to the battery, wherein the cooling device comprises a refrigerating sheet and a heat dissipation plate, the refrigerating sheet is located between the first PU layer and the second PU layer, and the refrigerating sheet is electrically connected to the substrate, and the refrigerating sheet is electrically connected to the battery, wherein the refrigerating sheet transfers heat to the cooling plate by bonding a heat dissipation surface of the refrigerating sheet to the heat dissipation plate.

2. The multifunctional belt for slimming, conditioning cervical spine pain and cooling according to claim 1, wherein the belt body further comprises a heating sheet, the heating sheet is located between the first PU layer and the conductive film layer, and a high-temperature-resistant double-sided adhesive tape is arranged between the first PU layer and the heating sheet, the heating sheet is electrically connected to the conductive film layer, the heating sheet is electrically connected to the substrate, and the heating sheet is electrically connected to the battery.

3. The multifunctional belt for slimming, conditioning cervical spine pain and cooling according to claim 1, wherein the belt body further comprises an SBR layer and a thermal insulation cotton layer, the SBR layer is located below the first PU layer, the conductive film layer is arranged below the SBR layer, and the thermal insulation cotton layer is arranged below the conductive film layer.

4. The multifunctional belt for slimming, conditioning cervical spine pain and cooling according to claim 1, further comprising a control and adjustment device, wherein the control and adjustment device is located in middle of a surface of the belt body, wherein the control and adjustment device is electrically connected to the cervical spine massage device, the control and adjustment device is electrically connected to the cooling device, and the control and adjustment device is electrically connected to the battery; the control and adjustment device comprises a housing, a control circuit board, control and adjustment buttons, a display screen, wherein the control circuit board is arranged inside the housing, the control and adjustment buttons are arranged on the control circuit board, the display screen is arranged above the housing, and the control circuit board is electrically connected with the control and adjustment button and the display screen, the control circuit board is electrically connected to the conductive film layer, the control circuit board is electrically connected to the heating sheet, and the control circuit board is electrically connected to the substrate, the control and adjustment buttons are electrically connected with the substrate and the massage points, wherein several contacts are arranged on bottom of the housing, and the contacts are electrically connected to contacts on an outer surface of the belt body, and the contacts on the outer surface of the belt body are electrically connected to the conductive film layer through wires, the control circuit board is electrically connected to the refrigerating sheet through wires, and the control and adjustment buttons are electrically connected to the refrigerating sheet.

5. The multifunctional belt for slimming, conditioning cervical spine pain and cooling according to claim 1, wherein a plurality of installation holes are arranged in an inner layer of the silicon layer, and the massage points on the substrate protrude from an inner surface of the silicon layer through the installation holes, and an inner surface of the substrate of the massage points is attached to an outer surface of the inner layer of the silicon layer, and a massage area is provided in middle of the outer surface of the substrate of the massage points, and a plurality of massage protrusions are arranged on the massage area.

6. The multifunctional belt for slimming, conditioning cervical spine pain and cooling according to claim 2, wherein the heating sheet is a graphene heating sheet, and the graphene heating sheet is heated by DC current.

7. The multifunctional belt for slimming, conditioning cervical spine pain and cooling according to claim 6, wherein one side of the heating sheet is provided with a conductive electrode, the conductive electrode on the heating sheet is electrically connected to the conductive film layer, and the conductive electrode is electrically connected to the battery.

8. The multifunctional belt for slimming, conditioning cervical spine pain and cooling according to claim 1, wherein the wires are a flexible and flat structure.

9. The multifunctional belt for slimming, conditioning cervical spine pain and cooling according to claim 1, wherein the first PU layer and the second PU layer are made of leather, weaving and canvas.
